(19) United States
(12) Patent Application Publication
(10) Pub. No.: US 2026/0291364 A1
(43) Pub. Date: Sep. 24, 2026

(54) THREE-PHASE RESONANT CONVERTER AND METHOD OF CONTROLLING THE SAME

(71) Applicant: DELTA ELECTRONICS, INC., Taoyuan City (TW)

(72) Inventors: Te-Chih PENG, Taoyuan City (TW); Chao-Fong CHANG, Taoyuan City (TW); Ming-Hsiang LO, Taoyuan City (TW)

(21) Appl. No.: 19/683,424

(22) Filed: May 20, 2026

Related U.S. Application Data
(63) Continuation of application No. 18/474,556, filed on Sep. 26, 2023, now Pat. No. 12,671,311.

(30) Foreign Application Priority Data
Jul. 17, 2023 (CN) 202310872970.X

(51) Int. Cl. H02M 1/00; H02M 3/00; H02M 3/335

(52) U.S. Cl. CPC H02M 1/0043; H02M 3/01; H02M 3/33561; H02M 3/33569; H02M 3/33576

(57) ABSTRACT

A three-phase resonant converter includes a three-phase transformer, an input bridge arm assembly, an output bridge arm assembly, a current balance controller, and a control unit. The input bridge arm assembly has first, second, and third input switch arms, each having an upper switch and a lower switch. The output bridge arm assembly has first, second, and third output synchronous rectification switch arms, each having an upper rectification switch and a lower rectification switch. The current balance controller receives first, second, and third currents from respective nodes between the upper and lower switches, determines first and second phase angle differences based on at least one of peak, average, or RMS values of the currents, and provides the phase angle differences to the control unit. The control unit controls turn-on timing of rectification switches using a first phase angle and second and third phase angles offset by the phase angle differences.

### CROSS-REFERENCE TO RELATED APPLICATIONS

This application is a continuation application of and claims priority under 35 U.S.C. § 120 to U.S. patent application Ser. No. 18/474,556, filed on Sep. 26, 2023, which claims priority to Chinese Patent Application No. 202310872970.X, filed on Jul. 17, 2023, under 35 U.S.C. § 119. The entire contents of the above applications are incorporated herein by reference for all purposes.

### BACKGROUND

### Technical Field

The present disclosure relates to a resonant converter and a method of controlling the same, and more particularly to a three-phase resonant converter and a method of controlling the same.

### Description of Related Art

The statements in this section merely provide background information related to the present disclosure and do not necessarily constitute prior art.

Due to soft-switching characteristics, the resonant converter has better conversion efficiency than the traditional DC-to-DC converter, and therefore the resonant converter has been widely used in various power supply products in recent years, among which the LLC structure is more common. However, the resonant converter has the characteristic that high gain and high efficiency cannot be satisfied at the same time: if the characteristic curve is optimized for high efficiency, the gain capability will be sacrificed, resulting in the inability to meet the current market requirement that the output voltage of the power converter needs to be maintained at a certain output level (referred to as the voltage threshold in the following) for a hold-up time when the input power is lost. Conversely, if optimized for a high gain curve, the efficiency will be sacrificed for increased energy consumption.

Existing control strategies have been successfully applied to single-phase resonant converters. However, with the gradual development of power supply products to higher output power, the application of single-phase resonant converters began to appear inadequate. In order to achieve three-phase current balance in three-phase resonant converters, a common method used in the past was to independently adjust the duty cycle of the three phases. However, this method cannot make the duty cycle of the three phases operate at the optimum point, thereby affecting efficiency. Another common method is to adjust the relative angles of the three-phase duty cycle so that the three phases are not fixed at 120 degrees from each other so as to achieve current balance, but the control difficulty of this method is relatively high.

Therefore, how to design a three-phase resonant converter and a method of controlling the same to solve the problems and technical bottlenecks in the existing technology has become a critical topic in this field.

### SUMMARY

The present disclosure provides a three-phase resonant converter and a method of controlling the same. In one aspect, the three-phase resonant converter includes a three-phase transformer, an input bridge arm assembly having first, second, and third input switch arms respectively coupled to primary-side windings of the three-phase transformer, and an output bridge arm assembly having first, second, and third output synchronous rectification switch arms respectively coupled to secondary-side windings of the three-phase transformer. Each input switch arm includes an upper switch and a lower switch, and each output synchronous rectification switch arm includes an upper rectification switch and a lower rectification switch. A control unit generates switching signals to control the input bridge arm assembly and the output bridge arm assembly.

In another aspect, the three-phase resonant converter includes a current balance controller coupled to the control unit. The current balance controller receives a first current, a second current, and a third current corresponding to currents flowing from respective nodes between the upper switches and the lower switches of the first, second, and third input switch arms toward the three-phase transformer. The current balance controller determines a first phase angle difference and a second phase angle difference based on the first current, the second current, and the third current, wherein the determining is based on at least one of a peak value, an average value, or a root-mean-square value of each of the currents. The current balance controller provides the phase angle differences to the control unit so that the control unit controls turn-on timing of rectification switches of the first, second, and third output synchronous rectification switch arms according to phase angles that include a first phase angle and offsets derived from the first phase angle difference and the second phase angle difference.

In yet another aspect, a method of controlling a three-phase resonant converter includes receiving, determining, and providing the phase angle differences as described above, and controlling the output synchronous rectification switch arms according to the phase angles corresponding to the phase angle differences.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a three-phase resonant converter according to the present disclosure.

FIG. 2A is a schematic waveform of switch signals of operating a conventional three-phase resonant converter at a frequency being less than a frequency threshold.

FIG. 2B is a schematic waveform of switch signals of operating the conventional three-phase resonant converter at a frequency being greater than the frequency threshold.

FIG. 3A is a schematic waveform of switch signals of operating the three-phase resonant converter at a frequency being less than the frequency threshold according to the present disclosure.

FIG. 3B is a schematic waveform of switch signals of operating the three-phase resonant converter at a frequency being greater than the frequency threshold according to the present disclosure.

FIG. 4 is a block diagram of a current balance controller according to the present disclosure.

FIG. 5A is a schematic waveform of an unbalanced input current of the three-phase resonant converter of the present disclosure.

FIG. 5B is a schematic waveform of a balanced input current of the three-phase resonant converter of the present disclosure.

FIG. 6A to FIG. 6H are circuit diagrams of three primary-side windings of a three-phase transformer according to different embodiments of the present disclosure.

FIG. 7A and FIG. 7B are circuit diagrams of three secondary-side windings of the three-phase transformer according to different embodiments of the present disclosure.

FIG. 8 is a flowchart of a method of controlling the three-phase resonant converter according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

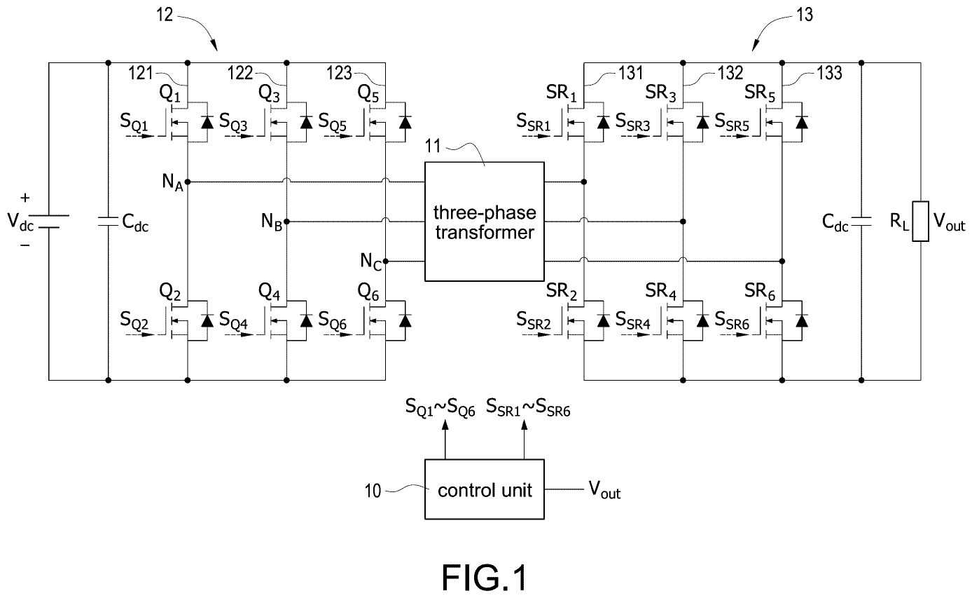

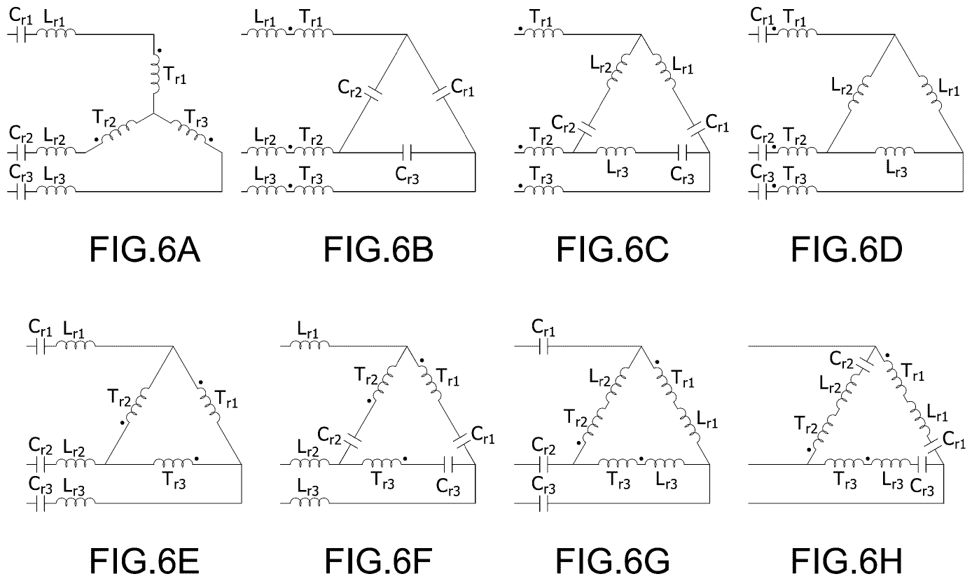

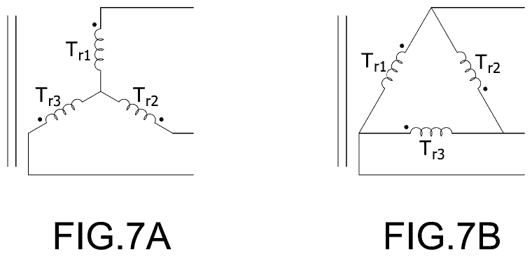

Please refer to FIG. 1, which shows a block circuit diagram of a three-phase resonant converter according to the present disclosure. The three-phase resonant converter includes a three-phase transformer 11, an input bridge arm assembly 12, an output bridge arm assembly 13, and a control unit 10. The three-phase transformer 11 includes a resonant circuit (having resonant capacitors Cr1-Cr3 and resonant inductors Lr1-Lr3), and three primary-side windings and three secondary-side windings. The control strategy proposed in the present disclosure may be applied to various three-phase resonant converter structures, and as shown in FIG. 6A to FIG. 6H, the three primary-side windings of the three-phase transformer 11 are star-connected (wye-connected) or delta-connected (triangle-connected), and as shown in FIG. 7A and FIG. 7B, the three secondary-side windings of the three-phase transformer 11 are star-connected or delta-connected.

The input bridge arm assembly 12 includes three input switch bridge arms 121, 122, 123, i.e., a first input switch bridge arm 121, a second input switch bridge arm 122, and a third input switch bridge arm 123, respectively coupled to the three primary-side windings. Each input switch bridge arm 121, 122, 123 includes an upper switch Q₁, Q₃, Q₅ and a lower switch Q₂, Q₄, Q₆, that is, the first input switch bridge arm 121 includes a first upper switch Q₁ and a first lower switch Q₂, and the first upper switch Q₁ and the first lower switch Q₂ are commonly connected at a first node N_{A}. The second input switch bridge arm 122 includes a second upper switch Q₃ and a second lower switch Q₄, and the second upper switch Q₃ and the second lower switch Q₄ are commonly connected at a second node N_{B}. The third input switch bridge arm 123 includes a third upper switch Q₅ and a third lower switch Q₆, and the third upper switch Q₅ and the third lower switch Q₆ are commonly connected at a third node N_{C}.

The output bridge arm assembly includes three output synchronous rectification switch arms 131, 132, 133, i.e., a first output synchronous rectification switch arm 131, a second output synchronous rectification switch arm 132, and a three output synchronous rectification switch arm 133, respectively coupled to the three secondary-side windings. Each output synchronous rectification switch arm 131, 132, 133 includes an upper rectification switch SR₁, SR₃, SR₅ and a lower rectification switch SR₂, SR₄, SR₆, that is, the first output synchronous rectification switch arm 131 includes a first upper rectification switch SR₁ and a first lower rectification switch SR₂. The second output synchronous rectification switch arm 132 includes a second upper rectification switch SR₃ and a second lower rectification switch SR₄. The third output synchronous rectification switch arm 133 includes a third upper rectification switch SR₅ and a third lower rectification switch SR₆.

In particular, the control of each output synchronous rectification switch arm 131, 132, 133 is corresponding to the control of each input switch arm 121, 122, 123. Specifically, the control of the first upper rectification switch SR₁ and the first lower rectification switch SR₂ of the first output synchronous rectification switch arm 131 is corresponding to the first upper switch Q₁ and the first lower switch Q₂ of the first input switch bridge arm 121. The control of the second upper rectification switch SR₃ and the second lower rectification switch SR₄ of the second output synchronous rectification switch arm 132 is corresponding to the second upper switch Q₃ and the second lower switch Q₄ of the second input switch bridge arm 122. The control of the third upper rectification switch SR₅ and the third lower rectification switch SR₆ of the third output synchronous rectification switch arm 133 is corresponding to the third upper switch Q₅ and the third lower switch Q₆ of the third input switch bridge arm 123.

In different embodiments, the controller unit 10 may receive an input voltage Vdc or the output voltage Vout of the three-phase resonant converter, that is, as long as the state of the output voltage Vout can be directly or indirectly acquired, it can be a source of voltage information. Taking the embodiment of receiving the output voltage Vout in FIG. 1 as an example, the control unit 10 provides input bridge arm switch signals S_{Q1}-S_{Q6} to respectively control the upper switches Q₁, Q₃, Q₅ and the lower switches Q₂, Q₄, Q₆ and provides output bridge arm switch signals S_{SR1}-S_{SR6} to respectively control the upper rectification switches SR₁, SR₃, SR₅ and the lower rectification switches SR₂, SR₄, SR₆ according to the output voltage Vout so that the upper rectification switch SR₁, SR₃, SR₅ or the lower rectification switch SR₂, SR₄, SR₆ to be correspondingly turned on with a phase angle leading to the upper switch Q₁, Q₃, Q₅ or the lower switch Q₂, Q₄, Q₆ so as to maintain the output voltage Vout of the resonant converter to be higher than a voltage threshold. Accordingly, when the three-phase resonant converter is shut down or the input power source does not supply power, the hold-tup time for the output voltage Vout to be kept at the output level can be extended. The detailed operation and principle will be explained later.

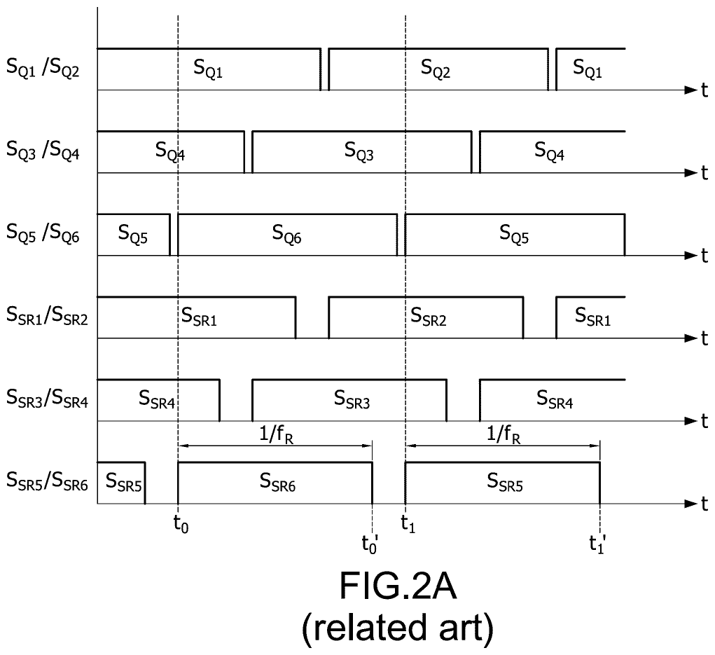

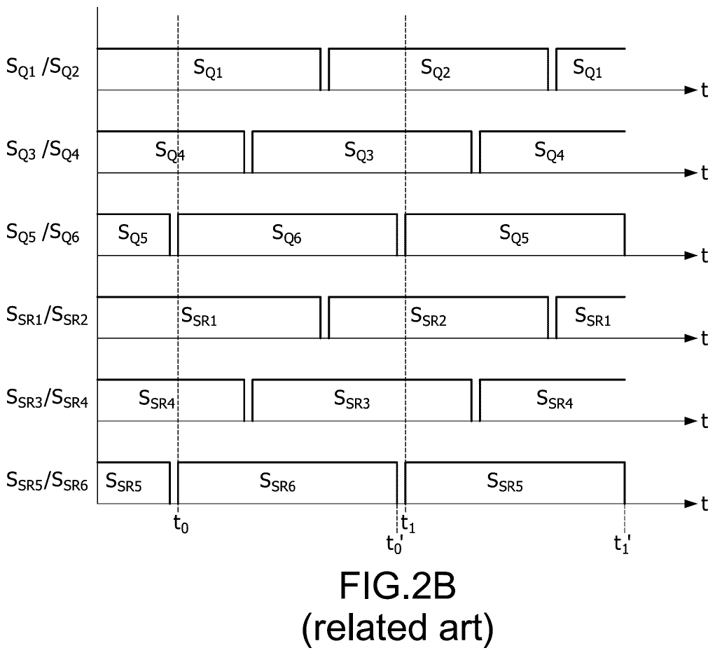

Please refer to FIG. 2A and FIG. 2B, which respectively show schematic waveforms of switch signals of operating a conventional three-phase resonant converter at a frequency being less than a frequency threshold and at the frequency being greater than the frequency threshold. As shown in FIG. 2A, when the resonant converter operates at the frequency being less than the frequency threshold, such as but not limited to, a resonant frequency of the resonant converter, and the resonant frequency will be described later as examples, in order to avoid the hard switching of the synchronous rectification switch on the output side, resulting in increased switching loss, the turned-on time period is reduced. For example, a time period of turning on the third lower rectification switch SR₆ shown in the figures is the resonant period 1/f_{R}. However, it will reduce the hold-up time that the power supply can maintain the output voltage at a certain/specific output level when the power supply is turned off or the input power source does not supply power. The resonant converter operating above the resonant frequency (as shown in FIG. 2B) is less likely to have this situation than the resonant converter operating below the resonant frequency.

Therefore, in order to solve the situation that the switching mode and the hold-up time of the switches cannot be considered in the previous disclosure, the present disclosure provides a three-phase resonant converter and a method of controlling the same to solve the existing problems and technical bottlenecks in the related art.

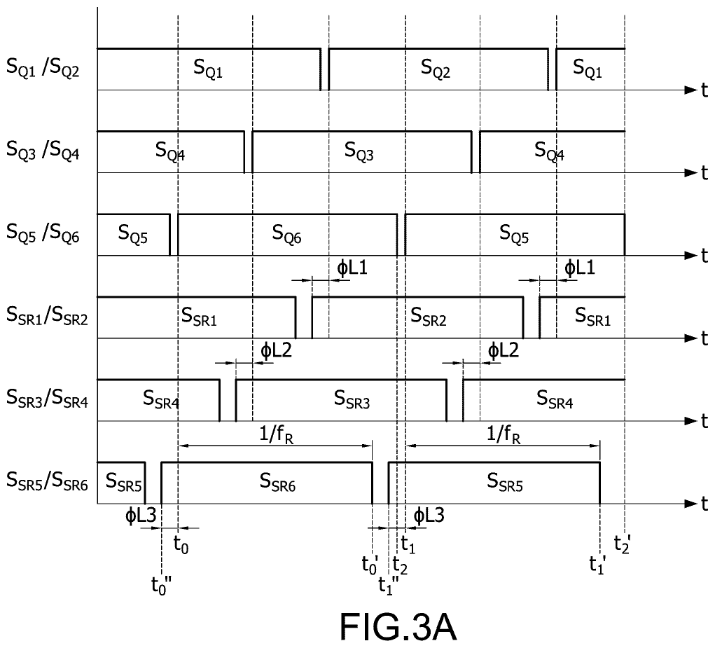

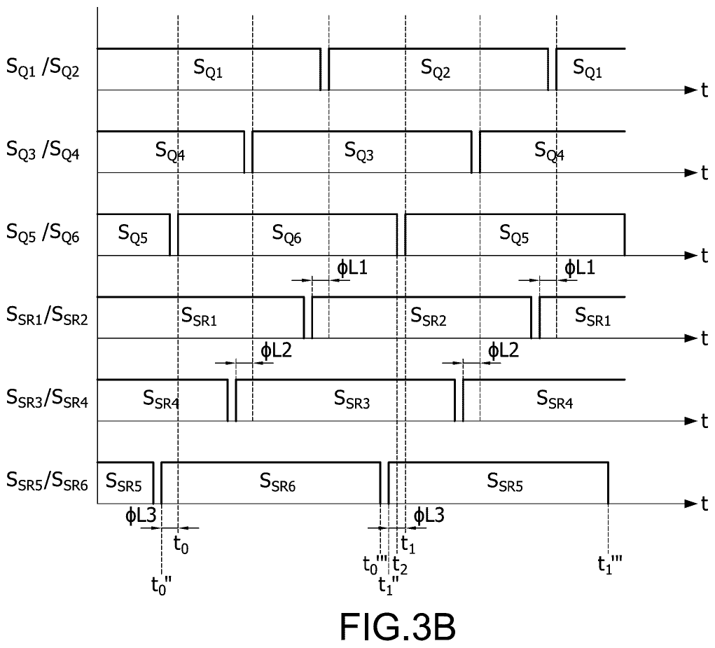

Please refer to FIG. 3A, which shows a schematic waveform of switch signals of operating the three-phase resonant converter at a frequency being less than the frequency threshold according to the present disclosure. The control unit 10 acquires a working frequency command according to the output voltage Vout of the three-phase resonant converter. Based on the working frequency command being less than the frequency threshold (for example, the resonant frequency f_{R}) of the resonant converter, the upper rectification switch SR₁, SR₃, SR₅ or the lower rectification switch SR₂, SR₄, SR₆ is correspondingly turned on with a phase angle leading to the upper switch Q₁, Q₃, Q₅ or the lower switch Q₂, Q₄, Q₆. That is, the first upper rectification switch SR₁ is turned on with a first phase angle ΦL1 leading to the first upper switch Q₁, or the first lower rectification switch SR₂ is turned on with the first phase angle ΦL1 leading to the first lower switch Q₂. Similarly, the second upper rectification switch SR₃ is turned on with a second phase angle ΦL2 leading to the second upper switch Q₃, or the second lower rectification switch SR₄ is turned on with the second phase angle ΦL2 leading to the second lower switch Q₄. Similarly, the third upper rectification switch SR₅ is turned on with a third phase angle ΦL3 leading to the third upper switch Q₅, or the third lower rectification switch SR₆ is turned on with the third phase angle ΦL3 leading to the third lower switch Q₆.

In this operation, since the upper rectification switch SR₁, SR₃, SR₅ or the lower rectification switch SR₂, SR₄, SR₆ is correspondingly turned on with the phase angle leading to the upper switch Q₁, Q₃, Q₅ or the lower switch Q₂, Q₄, Q₆, compared to the FIG. 2A (the time period of turning on the rectification switch SR₆ is the resonant period 1/f_{R}), the turned-on time period is greater than the resonant period 1/f_{R}, wherein the resonant period 1/f_{R} is the reciprocal of the resonant frequency f_{R}.

Moreover, as shown in FIG. 3A, a time point of turning on the upper rectification switch SR₁, SR₃, SR₅ or turning on the lower rectification switch SR₂, SR₄, SR₆ is earlier than a time point of turning on the corresponding upper switch Q₁, Q₃, Q₅ or lower switch Q₂, Q₄, Q₆; a time point of turning off the upper rectification switch SR₁, SR₃, SR₅ or turning off the lower rectification switch SR₂, SR₄, SR₆ is earlier than a time point of turning off the corresponding upper switch Q₁, Q₃, Q₅ or lower switch Q₂, Q₄, Q₆, and the time period of turning on the upper rectification switch SR₁, SR₃, SR₅ or turning on the lower rectification switch SR₂, SR₄, SR₆ at different switching cycles gradually increases with time. Specifically, taking the third lower rectification switch SR₆ and the third lower switch Q₆ as an example. A time point (time t0″) of turning on the third lower rectification switch SR₆ is earlier than a time point (time t0) of turning on the three lower switch Q₆, and a time point (time t0′) of turning off the third lower rectification switch SR₆ is earlier than a time point (time t2) of turning off the third lower switch Q₆. The same is true for other upper and lower rectification switches and the corresponding upper and lower switches.

Please refer to FIG. 3B, which shows a schematic waveform of switch signals of operating the three-phase resonant converter at a frequency being greater than the frequency threshold according to the present disclosure. The control unit 10 acquires the working frequency command according to the output voltage Vout of the three-phase resonant converter. Based on the working frequency command being greater than the frequency threshold (for example, the resonant frequency f_{R}) of the resonant converter, the upper rectification switch SR₁, SR₃, SR₅ or the lower rectification switch SR₂, SR₄, SR₆ is correspondingly turned on with a phase angle leading to the upper switch Q₁, Q₃, Q₅ or the lower switch Q₂, Q₄, Q₆. That is, the first upper rectification switch SR₁ is turned on with a first phase angle ΦL1 leading to the first upper switch Q₁, or the first lower rectification switch SR₂ is turned on with the first phase angle ΦL1 leading to the first lower switch Q₂. The same is true for other upper and lower rectification switches and the corresponding upper and lower switches.

Moreover, as shown in FIG. 3B, a time point of turning on the upper rectification switch SR₁, SR₃, SR₅ or turning on the lower rectification switch SR₂, SR₄, SR₆ is earlier than a time point of turning on the corresponding upper switch Q₁, Q₃, Q₅ or lower switch Q₂, Q₄, Q₆, and a time period of turning on the upper rectification switch SR₁, SR₃, SR₅ or turning on the lower rectification switch SR₂, SR₄, SR₆ is equal to a time period of turning on the corresponding upper switch Q₁, Q₃, Q₅ or lower switch Q₂, Q₄, Q₆. Specifically, taking the third lower rectification switch SR₆ and the third lower switch Q₆ as an example. A time point (time t0″) of turning on the third lower rectification switch SR₆ is earlier than a time point (time t0) of turning on the three lower switch Q₆, and a time period of turning on the third lower rectification switch SR₆ (from time t0″ to time t0′″) is equal to a time period of turning on the third lower switch Q₆ (from time t0 to time t2). The same is true for other upper and lower rectification switches and the corresponding upper and lower switches.

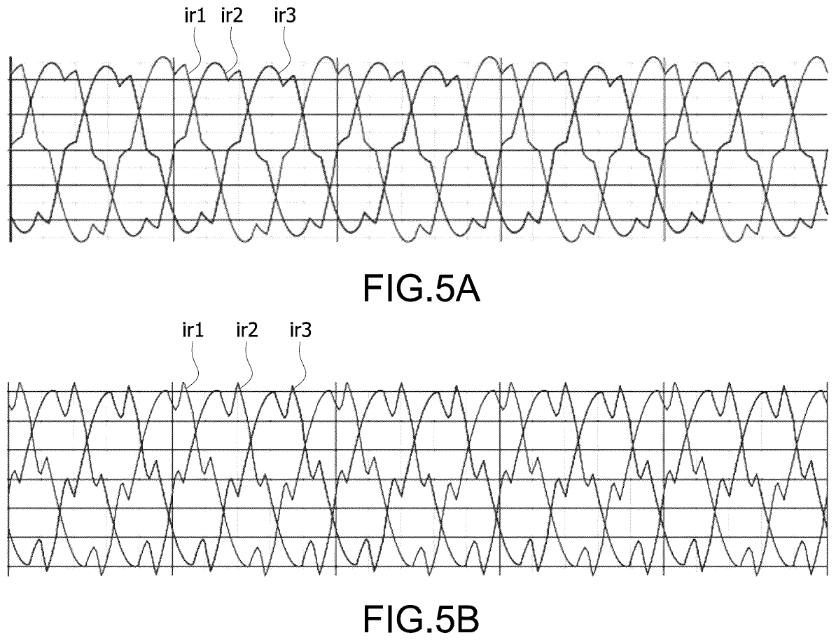

In one operation situation, based on three input currents flowing into the three primary-side windings being the same, that is, the input currents of the three-phase resonant converter are balanced (refer to FIG. 5B), the three phase angles which the three upper rectification switches SR₁, SR₃, SR₅ or the three lower rectification switches SR₂, SR₄, SR₆ are correspondingly turned on leading to the three upper switches Q₁, Q₃, Q₅ or the three lower switches Q₂, Q₄, Q₆ are the same. In another operation situation, based on three input currents flowing into the three primary-side windings being not the same, that is, the input currents of the three-phase resonant converter are not balanced (refer to FIG. 5A), the three phase angles which the three upper rectification switches SR₁, SR₃, SR₅ or the three lower rectification switches SR₂, SR₄, SR₆ are correspondingly turned on leading to the three upper switches Q₁, Q₃, Q₅ or the three lower switches Q₂, Q₄, Q₆ are not the same. The specific description of the above two operation situations is as follows.

Please refer to FIG. 3A and FIG. 3B, the first upper rectification switch SR₁ and the first lower rectification switch SR₂ are correspondingly turned on with a first phase angle ΦL1 leading to the first upper switch Q₁ and the first lower switch Q₂. The second upper rectification switch SR₃ and the second lower rectification switch SR₄ are correspondingly turned on with a second phase angle ΦL2 leading to the second upper switch Q₃ and the second lower switch Q₄. The third upper rectification switch SR₅ and the third lower rectification switch SR₆ are correspondingly turned on with a third phase angle ΦL3 leading to the third upper switch Q₅ and the third lower switch Q₆. In particular, the relationships between the first phase angle ΦL1, the second phase angle ΦL2, and the third phase angle ΦL3 are:

the second phase angle ΦL2 is equal to the first phase angle ΦL1 plus a first phase angle difference ΔΦL12, that is, ΦL2=ΦL1+ΔΦL12;

the third phase angle ΦL3 is equal to the first phase angle ΦL1 plus a second phase angle difference ΔΦL13, that is, ΦL3=ΦL1+ΔΦL13.

For the balanced-current operation situation of the three-phase resonant converter, since the first phase angle difference ΔΦL12 and the second phase angle difference ΔΦL13 are zero, the first phase angle ΦL1, the second phase angle ΦL2, and the third phase angle ΦL3 are the same.

For the unbalanced-current operation situation of the three-phase resonant converter, since the first phase angle difference ΔΦL12 and the second phase angle difference ΔΦL13 are not zero, the first phase angle ΦL1, the second phase angle ΦL2, and the third phase angle ΦL3 are not the same.

Moreover, the first phase angle difference ΔΦL12 is determined by a first current Ir1 and a second current Ir2, and the second phase angle difference ΔΦL13 is determined by the first current Ir1 and a third current Ir3. In particular, the first current Ir1 is a current flowing from a command node, i.e., a first node N_{A} between the first upper switch Q₁ and the first lower switch Q₂ to the three-phase transformer 11, the second current Ir2 is a current flowing from a command node, i.e., a second node N_{B} between the second upper switch Q₃ and the second lower switch Q₄ to the three-phase transformer 11, and the third current Ir3 is a current flowing from a command node, i.e., a third node N_{C} between the third upper switch Q₅ and the third lower switch Q₆ to the three-phase transformer 11.

When the second current Ir2 is greater than the first current Ir1, the first phase angle difference ΔΦL12 is negative, and when the second current Ir2 is less than the first current Ir1, the first phase angle difference ΔΦL12 is positive. Moreover, an absolute value of a current difference between the second current Ir2 and the first current Ir1 is greater, an absolute value of the first phase angle difference ΔΦL12 is greater. That is, when the second current Ir2 is increasingly greater than the first current Ir1, the first phase angle difference ΔΦL12 is a decreasingly negative value, and when the second current Ir2 is decreasingly less than the first current Ir1, the first phase angle difference ΔΦL12 is an increasingly positive value.

Similarly, when the third current Ir3 is greater than the first current Ir1, the second phase angle difference ΔΦL13 is negative, and when the third current Ir3 is less than the first current Ir1, the second phase angle difference ΔΦL13 is positive. Moreover, an absolute value of a current difference between the third current Ir3 and the first current Ir1 is greater, an absolute value of the second phase angle difference ≢ΦL13 is greater. That is, when the third current Ir3 is increasingly greater than the first current Ir1, the second phase angle difference ΔΦL13 is a decreasingly negative value, and when the third current Ir3 is decreasingly less than the first current Ir1, the second phase angle difference ΔΦL13 is an increasingly positive value.

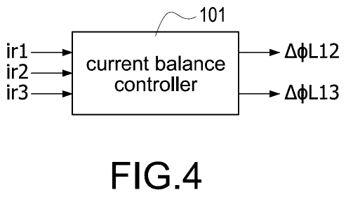

Please refer to FIG. 4, which shows a block diagram of a current balance controller according to the present disclosure. The three-phase resonant converter further includes a current balance controller 101. The current balance controller 101 receives the first current Ir1, the second current Ir2, and the third current Ir3, and calculates the first phase angle difference ΔΦL12 and the second phase angle difference ΔΦL13 according to peak values, average values, or root-mean-square values of the first current Ir1, the second current Ir2, and the third current Ir3.

Therefore, the unbalanced input currents are controlled by the current balance controller 101, and the phase angle differences are adjusted for the first phase angle ΦL1, the second phase angle ΦL2, and the third phase angle ΦL3 so as to achieve the optimum control of leading phase angle.

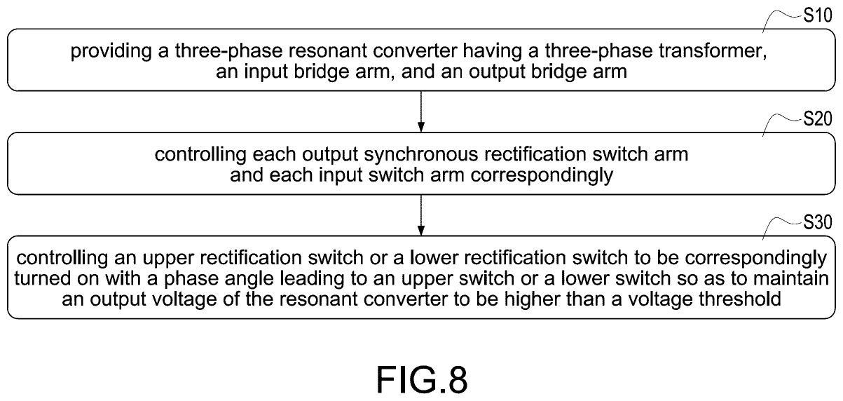

Please refer to FIG. 8, which shows a flowchart of a method of controlling the three-phase resonant converter according to the present disclosure. Cooperating with the complete description and diagrams of the previously disclosed three-phase resonant converter, the method of controlling the resonant converter of the present disclosure includes steps as follows. First, providing a three-phase resonant converter having a three-phase transformer, an input bridge arm, and an output bridge arm (step S10), wherein the input bridge arm assembly includes three input switch arms 121, 122, 123, and each input switch arm 121, 122, 123 includes an upper switch Q₁, Q₃, Q₅ and a lower switch Q₂, Q₄, Q₆; wherein the output bridge arm assembly includes three output synchronous rectification switch arms 131, 132, 133, and each output synchronous rectification switch arm 131, 132, 133 includes an upper rectification switch SR₁, SR₃, SR₅ and a lower rectification switch SR₂, SR₄, SR₆. Afterward, controlling each output synchronous rectification switch arm 131, 132, 133 and each input switch arm 121, 122, 123 correspondingly (step S20). Finally, controlling the upper rectification switch SR₁, SR₃, SR₅ or the lower rectification switch SR₂, SR₄, SR₆ to be correspondingly turned on with a phase angle leading to the upper switch Q₁, Q₃, Q₅ or the lower switch Q₂, Q₄, Q₆ so as to maintain an output voltage of the resonant converter to be higher than a voltage threshold (step S30). As for the more complete circuit structure and control method of the three-phase resonant converter, please refer to the content of the previous disclosure, and the detail description is omitted here for conciseness.

In summary, the present disclosure has the following features and advantages:
1. The three-phase resonant converter and the method of controlling the same can provide both high-gain and high-efficiency characteristics, and can be applied to higher output power design.
2. The unbalanced input currents can be controlled to adjust the phase angle differences for the first phase angle, the second phase angle, and the third phase angle so as to achieve the optimum control of leading phase angle and the balance of the three-phase current.
3. Three primary-side windings and three secondary-side windings of the three-phase transformer can be implemented in a star connection (Y connection) or a delta connection (Δ connection), thereby increasing the flexibility and convenience of circuit design.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A three-phase resonant converter, comprising:
a three-phase transformer comprising three primary-side windings and three secondary-side windings;
an input bridge arm assembly comprising a first input switch arm, a second input switch arm, and a third input switch arm respectively coupled to the three primary-side windings, each input switch arm comprising an upper switch and a lower switch;
an output bridge arm assembly comprising a first output synchronous rectification switch arm, a second output synchronous rectification switch arm, and a third output synchronous rectification switch arm respectively coupled to the three secondary-side windings, each output synchronous rectification switch arm comprising an upper rectification switch and a lower rectification switch;
a control unit configured to generate switching signals to control the input bridge arm assembly and the output bridge arm assembly; and
a current balance controller coupled to the control unit and configured to:
receive a first current, a second current, and a third current respectively corresponding to currents flowing from respective nodes between the upper switches and the lower switches of the first, second, and third input switch arms toward the three-phase transformer;
determine a first phase angle difference and a second phase angle difference based on the first current, the second current, and the third current; and
provide the first phase angle difference and the second phase angle difference to the control unit,
wherein the current balance controller determines the first phase angle difference and the second phase angle difference based on at least one of a peak value, an average value, or a root-mean-square value of each of the first current, the second current, and the third current,
wherein the control unit controls the first, second, and third output synchronous rectification switch arms such that:
turn-on timing of the upper rectification switch and the lower rectification switch of the first output synchronous rectification switch arm is controlled according to a first phase angle;
turn-on timing of the upper rectification switch and the lower rectification switch of the second output synchronous rectification switch arm is controlled according to a second phase angle equal to the first phase angle plus the first phase angle difference; and
turn-on timing of the upper rectification switch and the lower rectification switch of the third output synchronous rectification switch arm is controlled according to a third phase angle equal to the first phase angle plus the second phase angle difference.

2. The three-phase resonant converter of claim 1, wherein:
the first phase angle difference has a positive value when the second current is less than the first current and has a negative value when the second current is greater than the first current; and
the second phase angle difference has a positive value when the third current is less than the first current and has a negative value when the third current is greater than the first current.

3. The three-phase resonant converter of claim 2, wherein an absolute value of the first phase angle difference increases as an absolute value of a difference between the first current and the second current increases, and an absolute value of the second phase angle difference increases as an absolute value of a difference between the first current and the third current increases.

4. The three-phase resonant converter of claim 1, wherein the current balance controller is implemented as a control function executed by the control unit.

5. The three-phase resonant converter of claim 1, wherein, in response to the first current, the second current, and the third current being equal, the first phase angle difference and the second phase angle difference are zero.

6. The three-phase resonant converter of claim 1, wherein the three primary-side windings of the three-phase transformer are star-connected or delta-connected, and the three secondary-side windings of the three-phase transformer are star-connected or delta-connected.

7. The three-phase resonant converter of claim 1, wherein the control unit acquires a working frequency command according to an output voltage of the three-phase resonant converter, and controls the output bridge arm assembly based on whether the working frequency command is less than a frequency threshold of the three-phase resonant converter.

8. The three-phase resonant converter of claim 7, wherein, based on the working frequency command being less than the frequency threshold, a time period of turning on at least one rectification switch in each of the first, second, and third output synchronous rectification switch arms is longer than a period that is a reciprocal of the frequency threshold.

9. The three-phase resonant converter of claim 8, wherein, based on the working frequency command being less than the frequency threshold, a time point of turning on the at least one rectification switch is earlier than a time point of turning on a corresponding switch of the input bridge arm assembly, and a time point of turning off the at least one rectification switch is earlier than a time point of turning off the corresponding switch of the input bridge arm assembly.

10. The three-phase resonant converter of claim 9, wherein, based on the working frequency command being less than the frequency threshold, the time period of turning on the at least one rectification switch at different switching cycles gradually increases with time.

11. The three-phase resonant converter of claim 7, wherein the frequency threshold is a resonant frequency of the three-phase resonant converter.

12. A method of controlling a three-phase resonant converter, wherein the three-phase resonant converter comprises:
a three-phase transformer having three primary-side windings and three secondary-side windings,
an input bridge arm assembly having first, second, and third input switch arms respectively coupled to the three primary-side windings,
an output bridge arm assembly having first, second, and third output synchronous rectification switch arms respectively coupled to the three secondary-side windings, and
a current balance controller,
the method comprising:
receiving, by the current balance controller, a first current, a second current, and a third current respectively corresponding to currents flowing from respective nodes between upper switches and lower switches of the first, second, and third input switch arms toward the three-phase transformer;
determining, by the current balance controller, a first phase angle difference and a second phase angle difference based on the first current, the second current, and the third current, wherein the determining is based on at least one of a peak value, an average value, or a root-mean-square value of each of the first current, the second current, and the third current;
providing the first phase angle difference and the second phase angle difference from the current balance controller to a control unit; and
controlling, by the control unit, the first, second, and third output synchronous rectification switch arms such that:
turn-on timing of an upper rectification switch and a lower rectification switch of the first output synchronous rectification switch arm is controlled according to a first phase angle,
turn-on timing of an upper rectification switch and a lower rectification switch of the second output synchronous rectification switch arm is controlled according to a second phase angle equal to the first phase angle plus the first phase angle difference, and
turn-on timing of an upper rectification switch and a lower rectification switch of the third output synchronous rectification switch arm is controlled according to a third phase angle equal to the first phase angle plus the second phase angle difference.

13. The method of claim 12, wherein the first phase angle difference has a positive value when the second current is less than the first current and has a negative value when the second current is greater than the first current, and wherein the second phase angle difference has a positive value when the third current is less than the first current and has a negative value when the third current is greater than the first current.

14. The method of claim 13, wherein an absolute value of the first phase angle difference increases as an absolute value of a difference between the first current and the second current increases, and an absolute value of the second phase angle difference increases as an absolute value of a difference between the first current and the third current increases.

15. The method of claim 12, wherein, in response to the first current, the second current, and the third current being equal, the first phase angle difference and the second phase angle difference are zero.

16. The method of claim 12, wherein the three primary-side windings of the three-phase transformer are star-connected or delta-connected, and the three secondary-side windings of the three-phase transformer are star-connected or delta-connected.

17. The method of claim 12, further comprising acquiring, by the control unit, a working frequency command according to an output voltage of the three-phase resonant converter, and controlling the output bridge arm assembly based on whether the working frequency command is less than a frequency threshold.

18. The method of claim 17, wherein, based on the working frequency command being less than the frequency threshold, a time period of turning on at least one rectification switch in each output synchronous rectification switch arm is longer than a period that is a reciprocal of the frequency threshold.

19. The method of claim 18, wherein, based on the working frequency command being less than the frequency threshold, a time point of turning on the at least one rectification switch is earlier than a time point of turning on a corresponding switch of the input bridge arm assembly.

20. The method of claim 17, wherein the frequency threshold is a resonant frequency of the three-phase resonant converter.
